(19) United States
(12) Patent Application Publication
(10) Pub. No.: US 2003/0193731 A1
(43) Pub. Date: Oct. 16, 2003

(54) Balanced MR head bias technique for magneto-resistive preamplifier operating in a single supply environment

(75) Inventor: Davy H. Choi, Garland, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/063,325

(22) Filed: Apr. 11, 2002

(51) Int. Cl. G11B 5/03

(52) U.S. Cl. 360/66

(57) ABSTRACT

An MR head bias circuit (60) in a preamplifier includes a balanced driving circuit (62,64) for connection to the MR head (12) at respective first (66) and second (68) output nodes and impedance matching elements (72,74) to match an output impedance at each output node (66,68) to each other. The impedance matching elements (72,74) may match an output impedance at each output node (66,68) to make them substantially the same.

### BACKGROUND OF INVENTION

1. Field of Invention

This invention relates to improvements in methods and apparatuses for dynamic information storage or retrieval, and more particularly to improvements in methods and circuitry for biasing and operating an MR head for use, for example, in a mass data storage device, or the like, and still more particularly to improvements in methods and circuitry for operating an MR head for use, for example, in a mass data storage device, or the like, using a single power supply system in the MR head preamplifier circuit.

2. Relevant Background

Mass data storage devices include tape drives, as well as hard disk drives that have one or more spinning magnetic disks or platters onto which data is recorded for storage and subsequent retrieval. Hard disk drives may be used in many applications, including personal computers, set top boxes, video and television applications, audio applications, or some mix thereof. Applications for hard disk drives are still being developed, and are expected to further increase in the future.

Typically, in the construction of a hard disk drive, a data transducer, or head, is located in proximity to a spinning platter, or disk, on which a magnetic material has been emplaced. The magnetic material is arranged to support a pattern of rings along which the domains of the magnetic material may be selectively oriented in accordance with the recorded data, so that as the head flies over the magnetic material and along the paths of the rings, it can detect the orientation of the domains to enable the data to be read and decoded.

Recently, magneto-resistive (MR) heads have been finding increasing use in such disk drive applications. The term “magneto-resistive” refers to the change in resistivity of metals in the presence of a magnetic field. MR heads are gaining popularity primarily because MR heads efficiently convert magnetization changes into sufficiently high currents or voltages with a minimum amount of noise, detect signals at high densities with a negligible loss in signals, and are cost-effective.

Moreover, MR-sensor technology is extendable to very high disk drive densities. Among the many advantages of the MR heads is the fact that they are essentially independent of the velocity of the disk medium because they measure the flux from the medium, in contrast, for example, to inductive heads, which measure the change in flux with time. They can therefore find wide use in such applications as laptop computers, which have a relatively slowly rotating hard disk, as will as in high-end personal computers, which have rapidly rotating disks.

The systems in which MR heads are used typically employ a preamplifier circuit, among other things, to establish an operating bias on the MR head to enable the resistance changes above and below that established by the bias to be determined. However, in the past, differential MR preamplifier designs have used a dual power supply. A dual power supply is a power supply which has both a positive potential, Vdd, and a negative potential, Vee, to bias the common-mode voltage of the MR head at a reference potential, typically ground. However, in some cases, the MR head is allowed to be biased with a common mode voltage above ground, for example, by about 400 mV. If too great a DC potential exists between the head bias and ground, undesirable head arching may occur.

For many low power applications, single supply preamplifiers have been proposed because of their lower power dissipation. In low power applications, the same supply current at a lower supply voltage produces lower power dissipation. In a single supply system, there are techniques to satisfy the low head bias requirement; however, these conditions create degradations in both power supply rejection ratio (PSRR) and common mode rejection ratio (CMRR). Such degradations impact the overall noise rejection capability of the preamplifier design.

More particularly, for single supply designs, various MR head bias methods have been proposed. One biasing configuration 10, is shown in FIG. 1, and is often referred to as a “single-ended configuration”. In the single-ended configuration, the MR head is represented by a resistor Rmr, 12. One end of the resistor 12 is fed by a PMOS current source 14 while the other end is connected to ground. A second resistor 16 is connected between the source of the PMOS current source 14 and Vdd. The common mode voltage of the head is typically kept at about 100 mV above ground. This is called single-ended configuration because only one side 18 of the head, labeled HRX, is floating and available to be connected to a reader amplifier (not shown).

Another circuit configuration 20, often referred to as a “differential configuration” is shown in FIG. 2. One end of the MR head 12 is fed by a PMOS current source 22, while the other end is connected to an NMOS current sink 24 to ground. In this way, both terminals 26 and 28 of the MR head 12, labeled HRX and HRY, are available to be connected to a “differential” reader amplifier, such as the amplifier represented in FIG. 5. In the circuit embodiment 20 of FIG. 2, a resistor 30 connects the source of PMOS transistor 22 to Vdd. Although the circuits of FIGS. 1 and 2 are both considered single power supply circuits, they have generally poor CMRR and PSRR.

The circuit 10 of FIG. 1 has the poorest CMRR and PSRR characteristics due to its single-ended nature. Although being classified as a differential design, the circuit 20 of FIG. 2 does not present matched characteristics at the individual HRX and HRY terminals 26 and 28, due to different impedances seen at the two terminals.

What is needed, therefore, is a single power supply MR head preamplifier circuit that has generally good CMRR and PSRR characteristics.

### SUMMARY OF INVENTION

In light of the above, therefore, it is an object of the invention to provide a single power supply MR head bias circuit that has generally good CMRR and PSRR characteristics.

It is another object of the invention to provide an MR head bias circuit of the type described that has substantially the same output impedance at each output node for connection to an MR head.

These and other objects, features and advantages of the invention will be apparent to those skilled in the art from the following detailed description of the invention, when read in conjunction with the accompanying drawings and appended claims.

Thus, according to a broad aspect of the invention, an MR head bias circuit is presented. The circuit includes a balanced driving circuit for connection to the MR head at respective first and second output nodes and impedance matching elements to match an output impedance at each output node to each other, wherein the output impedances at each output node are substantially the same. The impedance matching elements may match an output capacitance at each output node.

According to another broad aspect of the invention, an MR head bias circuit having a single power supply with a voltage supply rail and a reference voltage rail at a potential below the voltage supply rail is presented. The circuit includes a first output terminal for connection to one side of an MR head and a pull-up transistor connected on one side to the first output terminal. A resistor is connected between another side of the pull-up transistor and the voltage supply rail. A second output terminal is provided for connection to another side of the MR head. A pull-down transistor is connected on one side to the reference voltage rail and on another side to the second output terminal. A first impedance matching transistor having impedance characteristics similar to the pull-up transistor connected between the second output terminal and the voltage supply rail, and a second impedance matching transistor having impedance characteristics similar to the pull-down transistor connected between the first output terminal and the reference voltage rail. The pull-up and first impedance matching transistors may be PMOS transistors, and the pull-down and the second impedance matching transistors may be NMOS transistors.

According to another broad aspect of the invention, an MR head bias circuit in a preamplifier is presented. The circuit has a single power supply with a supply voltage and a reference voltage at a potential below the supply voltage. The circuit has a first PMOS transistor connected on one side to a first output node for connection to one side of an MR head and a resistor between another side of the PMOS transistor and the supply voltage. A second output node is provided for connection to another side of the MR head. A first NMOS transistor is connected between the reference voltage and the second output node, and a second PMOS transistor having impedance characteristics similar to the first PMOS transistor is connected between the second output node and the voltage supply. A second NMOS transistor having impedance characteristics similar to the first NMOS transistor is connected between the first output node and the reference voltage.

According to yet another broad aspect of the invention, a method is presented for biasing an MR head. The method includes providing pull-up and pull-down transistors for connection to respective sides of the MR head at respective first and second output nodes. The method also includes connecting first and second impedance matching transistors having impedance characteristics similar to impedance characteristics respectively of the pull-up and pull-down transistors respectively to the second and first output nodes, whereby respective impedances at the first and second output nodes are substantially the same.

### BRIEF DESCRIPTION OF DRAWINGS

The invention is illustrated in the accompanying drawing, in which:

FIG. 1 is a single-ended, single supply circuit configuration for biasing an MR head, according to the prior art.

FIG. 2 is a differential, single supply circuit configuration for biasing an MR head, according to the prior art.

FIG. 3 is a block diagram of a generic disk drive system, illustrating the general environment in which the invention may be practiced.

FIG. 4 is an electrical schematic diagram of an MR head bias circuit in a preamplifier circuit, in accordance with a preferred embodiment of the invention.

FIG. 5 is an electrical schematic diagram showing the relationship of the MR head biasing circuit (MRBS), the head, and a balanced reader amplifier, in accordance with a preferred embodiment of the invention.

FIG. 6 is an electrical schematic diagram of an MR head bias circuit in a preamplifier circuit implementation, in accordance with a preferred embodiment of the invention.

FIG. 7 is an electrical schematic diagram of another MR head bias circuit in a preamplifier circuit implementation, in accordance with a preferred embodiment of the invention.

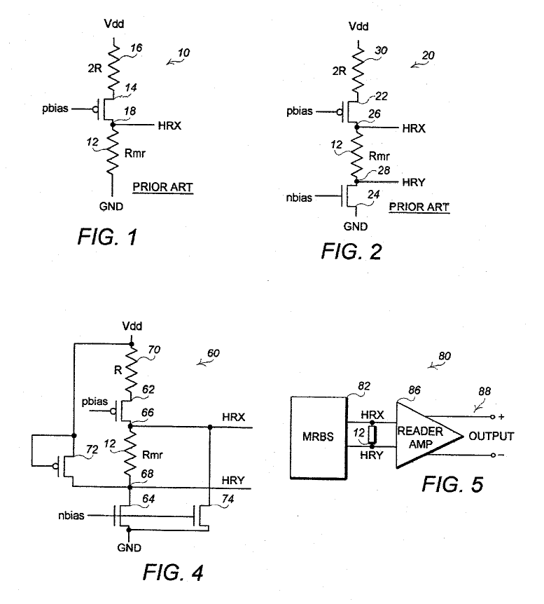

In the various figures of the drawing, like reference numerals are used to denote like or similar parts.

### DETAILED DESCRIPTION

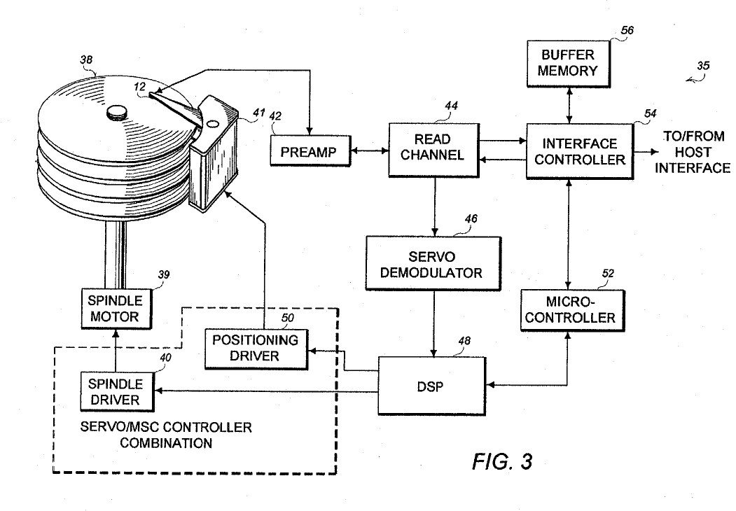

With reference now to FIG. 3, a block diagram of a generic disk drive system 35 is shown. The system 35 represents the general environment in which the invention may be practiced. The system 35 includes a magnetic media disk 38 that is rotated by a spindle motor 39 and spindle driver circuit 40. A data transducer or head 12 is locatable along selectable radial tracks (not shown) of the disk 38 by a voice coil motor 41.

The radial tracks may contain magnetic states that contain information about the tracks, such as track identification data, location information, synchronization data, as well as user data, and so forth. The head 12 is used both to record user data to and read user data back from the disk 38, as well as to detect signals that identify the tracks and sectors at which data is written, and to detect servo bursts that enable the head 12 to be properly laterally aligned with the tracks of the disk 38, as below described.

Analog electrical signals that are generated by the head 12 in response to the magnetic signals recorded on the disk 38 are preamplified by a preamplifier 42 for delivery to read channel circuitry 44. Servo signals are detected and demodulated by one or more servo demodulator circuits 46 and processed by a digital signal processor (DSP) 48 to control the position of the head 12 via the positioning driver circuit 50. The servo data that is read and processed may be analog data that is interpreted by the DSP 48 for positioning the head 12.

A microcontroller 52 is typically provided to control the DSP 48, as well as an interface controller 54 to enable data to be passed to and from a host interface (not shown) in known manner. A data memory 56 may be provided, if desired, to buffer data being written to and read from the disk 38.

The preamplifier 42 may contain the circuitry, 60 according to a preferred embodiment of the invention, which is broadly illustrated in FIG. 4, to which reference is now additionally made. In the circuitry 60 one end of the MR head 12 is fed by a PMOS current source 62, while the other end is connected to an NMOS current sink 64 to ground. In this way, both first and second output nodes or terminals 66 and 68 of the MR head 12, labeled HRX and HRY, are available to be connected to a differential reader amplifier (not shown).

In the circuit embodiment 60 of FIG. 4, a resistor 70 connects the source of a pull-up transistor, preferably a PMOS transistor 62, to Vdd, and a first impedance matching transistor, preferably a second PMOS transistor 72, is connected across the series combination of the head 12, PMOS transistor 62, and a resistor 70. On the other side of the circuit 60, a pull-down transistor, preferably an NMOS transistor 64, connects the second output node 68 to ground. A second impedance matching transistor, preferably a second NMOS transistor 74, is connected across the series combination of the head 12 and NMOS transistor 64 to ground.

Thus, the PMOS transistor 72 is connected across the PMOS transistor 62 in series with resistor 70, and NMOS transistor 74 is connected across the NMOS transistor 64 and resistance or the MR head 12. It can be seen that the output node 66 sees the impedance of the drain of the PMOS transistor 62, as well as the drain of the NMOS transistor 74. Likewise, the output terminal 68 sees the drains of the NMOS transistor 64 as well as the drain of the PMOS transistor 72. Therefore, in the circuit 60 the output is highly balanced, with highly matched impedances at the HRX and HRY terminals 66 and 68.

FIG. 5 shows a preamplifier reader configuration 80 in which the MR head Bias Circuit (MRBS) 82 feeds into a reader amplifier 86. Both the output CMR and output PSR are output signals measured at the output 88 with the input signal applied at the midpoint between HRX and HRY for CMR measurement, and with the input signal applied at the power supply pins for PSR measurements.

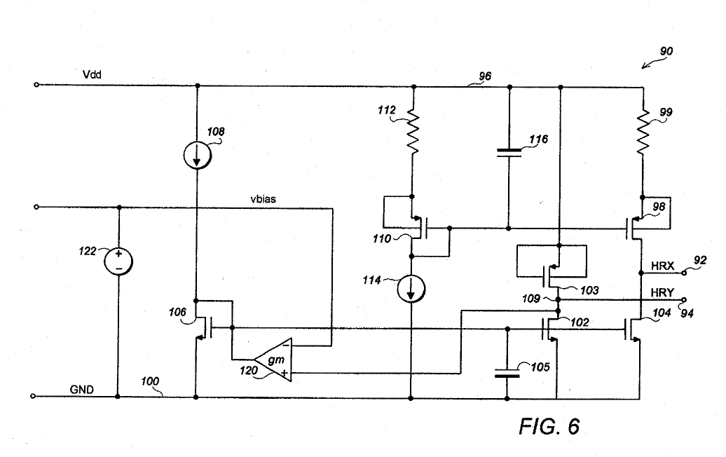

With reference now additionally to FIG. 6, a preferred implementation of the MR head bias circuit 90, according to the present invention, is shown. The circuit 90 is connectable to the MR head (not shown) at its output terminals 92 and 94, labeled HRX and HRY, respectively. Terminal 92 is connected to a Vdd line 96 by a PMOS pull-up transistor 98 through a resistor 99. Terminal 94 is connected to a ground (GND) line 100 by an NMOS pull-down transistor 102. A diode connected PMOS transistor 103 connects the drain of the NMOS transistor 102 to the Vdd line 96, and a current control transistor 104 connects the drain of PMOS transistor 98 to the GND line 100. The transistors 103 and 104 serve similar functions at the transistors 72 and 74 in the circuit 60 of FIG. 4 to balance both the resistive and capacitive loads on the output lines HRX and HRY on respective terminals 92 and 94.

The current through the PMOS transistor 98 is controlled by a current mirror, having the NMOS load transistor 104 connected to mirror the current in a diode connected NMOS transistor 106 that is in series with a current source 108. The current mirror also controls the current in the NMOS transistor 102. The PMOS transistor 98 is also connected as a part of a current mirror, which includes a diode connected PMOS transistor 110, resistor 112, and current source 114.

A capacitor 105 is connected from the gates of the NMOS transistors 106, 102, and 104 to the GND line 100, and a capacitor 116 is connected between the gates of the PMOS transistor 98 and 110 to the Vdd line 96. Capacitors 105 and 116 serve to bypass to ac ground any ac noise generated by the transistors of the circuit 90.

A transconductance amplifier 120 has its inverting input connected to the drains of transistors 102 and 103, and its noninverting input connected to a voltage source 122. The output of the transconductance amplifier 120 is connected to the gates of transistors 106, 102, and 104, thereby to maintain the node 109 at a predetermined bias voltage, vbias, established by the voltage source 122. Preferably, the node 109 is biased above ground since the circuit 90 is powered by a single supply. The bias voltage may be, for example about 0.4 volts.

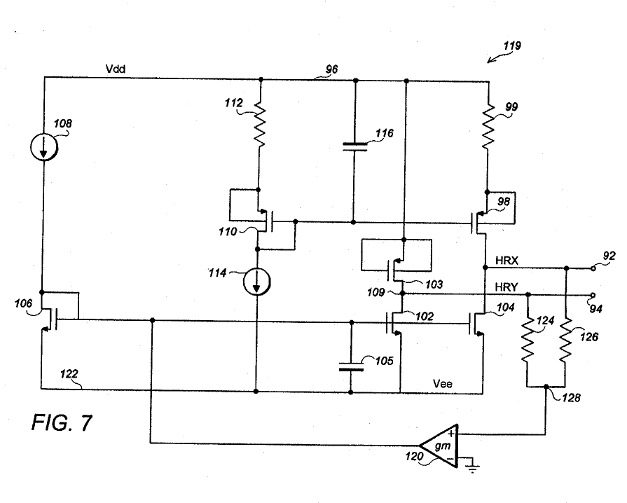

With reference now additionally to FIG. 7, another embodiment of the preamplifier circuit 119, according to the present invention, is shown. The circuit 119 is constructed similarly to the preamplifier circuit 90 of FIG. 6, except for the biasing circuit on the gates of transistors 106, 102, and 104. Additionally, unlike the circuit 90 of FIG. 6, which was referenced to a ground line 100, the preamplifier circuit 119 of FIG. 7 may be referenced to a different voltage, such as Vee, which is a potential below ground, on line 122.

The gates of transistors 102, 104, and 106 are biased by the output of a transconductance amplifier 120, which has its inverting input connected via a pair of resistors 124 and 126 to the output lines HRX 92 and HRY 94 to develop an average voltage therebetween on node 128. The noninverting input of the amplifier 120 is referenced to ground.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. An MR head bias circuit in a preamplifier comprising:
a balanced driving circuit for connection to said MR head at respective first and second output nodes; and
impedance matching elements to match an output impedance at each output node to each other, wherein said output impedance at each output node is substantially the same.

2. The MR head bias circuit of claim 1 further wherein said impedance matching elements match an output resistance and capacitance at each output node.

3. An MR head preamplifier circuit having a single power supply having a voltage supply rail and a reference voltage rail at a potential below said voltage supply rail, comprising:
a first output terminal for connection to one side of an MR head;
a pull-up transistor connected on one side to said first output terminal;
a resistor connected between another side of said pull-up transistor and said voltage supply rail;
a second output terminal for connection to another side of said MR head;
a pull-down transistor connected on one side to said reference voltage rail and on another side to said second output terminal;
a first impedance matching transistor having impedance characteristics similar to said pull-up transistor connected between said second output terminal and said voltage supply rail; and
a second impedance matching transistor having impedance characteristics similar to said pull-down transistor connected between said first output terminal and said reference voltage rail.

4. The MR head bias circuit of claim 3 wherein said pull-up and said first impedance matching transistors are PMOS transistors, and said pull-down and said second impedance matching transistors are NMOS transistors.

5. The MR head bias circuit of claim 4 wherein said reference voltage rail is at a ground potential.

6. The MR head bias circuit of claim 4 wherein said reference voltage rail is at a potential above a ground potential.

7. The MR head bias circuit of claim 4 wherein said similar impedance characteristics of said first impedance matching transistor is a capacitance.

8. The MR head bias circuit of claim 4 wherein said similar impedance characteristics of said second impedance matching transistor is a capacitance.

9. The MR head bias circuit of claim 4 further comprising a circuit to bias control elements of said pull-down and said second impedance matching transistors whereby a voltage of said second output terminal is maintained above a voltage of said reference voltage rail.

10. The MR head bias circuit of claim 9 wherein said circuit to bias control elements of said pull-down and said second impedance matching transistors comprises a reference voltage source.

11. The MR head bias circuit of claim 9 wherein said circuit to bias control elements of said pull-down and said second impedance matching transistors comprises a circuit to compare an average voltage between said first and second output terminals with a ground voltage.

12. The MR head bias circuit of claim 4 further comprising a current mirror circuit to control currents in said pull-up transistor.

13. The MR head bias circuit of claim 4 further comprising a current mirror circuit to control currents in said pull-down transistor and said second impedance matching transistor.

14. The MR head bias circuit of claim 4 further comprising a capacitor connected between a control element of said pull-up transistor and said voltage supply rail to bypass ac noise thereat.

15. The MR head bias circuit of claim 4 further comprising a capacitor connected between a control element of said pull-down transistor and said reference voltage rail to bypass ac noise thereat.

16. An MR head bias circuit in a preamplifier circuit having a single power supply with a supply voltage and a reference voltage at a potential below said supply voltage, comprising:
a first PMOS transistor connected on one side to a first output node for connection to one side of an MR head;
a resistor between another side of said PMOS transistor and said supply voltage;
a second output node for connection to another side of said MR head;
a first NMOS transistor between said reference voltage and said second output node;
a second PMOS transistor having impedance characteristics similar to said first PMOS transistor, between said second output node and said voltage supply; and
a second NMOS transistor having impedance characteristics similar to said first NMOS transistor, between said first output node and said reference voltage.

17. The preamplifier circuit of claim 16 wherein said reference voltage is at a ground potential.

18. The MR head bias circuit of claim 16 wherein said reference voltage is at a potential above a ground potential.

19. The MR head bias circuit of claim 16 wherein said similar impedance characteristics of said second PMOS transistor comprises a capacitive component.

20. The MR head bias circuit of claim 16 wherein said similar impedance characteristics of said second NMOS transistor comprises a capacitive component.

21. The MR head bias circuit of claim 16 further comprising a circuit to bias gate elements of said first and second NMOS transistors, whereby a voltage of said second output node is maintained above a voltage of said reference voltage.

22. The MR head bias circuit of claim 21 wherein said circuit to bias gate elements of said first and second NMOS transistors comprises a reference voltage source.

23. The MR head bias circuit of claim 21 wherein said circuit to bias control elements of said first and second NMOS transistors comprises a circuit to compare an average voltage between said first and second output nodes with a ground voltage.

24. The MR head bias circuit of claim 16 further comprising a current mirror circuit to control currents in said first PMOS transistor.

25. The MR head bias circuit of claim 16 further comprising a current mirror circuit to control currents in said first and second NMOS transistors.

26. A method for biasing an MR head, comprising:
providing pull-up and pull-down transistors for connection to respective sides of said MR head at respective first and second output nodes;
connecting first and second impedance matching transistors having impedance characteristics similar to impedance characteristics respectively of said pull-up and pull-down transistors respectively to said second and first output nodes, whereby respective impedances at said first and second output nodes are substantially the same.

27. The method of claim 26 further comprising providing a single power supply for said pull-up and pull-down transistors and said first and second impedance matching transistors.

28. The method of claim 26 wherein said similar impedance characteristics of said pull-up and pull-down transistors comprise capacitive components thereof.
